(19) United States
(12) Patent Application Publication
(10) Pub. No.: US 2025/0251090 A1
(43) Pub. Date: Aug. 7, 2025

(54) GAS SUPPLY SYSTEM FOR HIGH AND LOW-PRESSURE GAS- CONSUMING DEVICES AND METHOD FOR CONTROLLING SUCH SYSTEM

(71) Applicant: GAZTRANSPORT ET TECHNIGAZ, Saint Remy Les Chevreuse (FR)

(72) Inventors: Bernard AOUN, Saint Remy Les Chevreuse (FR); Charbel HOMSY, Saint Remy Les Chevreuse (FR); Romain NARME, Saint Remy Les Chevreuse (FR)

(73) Assignee: GAZTRANSPORT ET TECHNIGAZ, Saint Remy Les Chevreuse (FR)

(21) Appl. No.: 18/852,603

(22) PCT Filed: Mar. 15, 2023
(86) PCT No.: PCT/FR2023/050361

§ 371 Date: Sep. 30, 2024

(30) Foreign Application Priority Data
Apr. 7, 2022 (FR) FR2203212

(51) Int. Cl. F17C 9/04

(52) U.S. Cl. CPC F17C 9/04; F17C 2205/0326; F17C 2221/033; F17C 2223/0153; F17C 2223/033; F17C 2223/036; F17C 2225/0123; F17C 2225/033; F17C 2225/036; F17C 2227/0135; F17C 2227/0157; F17C 2227/0178; F17C 2227/0306; F17C 2250/032; F17C 2250/0439; F17C 2250/0443; F17C 2250/0636; F17C 2265/066; F17C 2270/0105

(57) ABSTRACT

A supply system for supplying a high-pressure gas-consuming device and a low-pressure gas-consuming device includes: a first supply circuit, a second supply circuit, a return line, a first heat exchanger, a second heat exchanger, a heat treatment branch connected to the second supply circuit, and a third heat exchanger configured to operate a heat exchange between the gas flowing through the heat treatment branch and the gas flowing through the return line.

The present invention relates to the domain of ships to store and/or transport liquid-state gas and relates more specifically to a gas supply system for gas-consuming devices that such ships comprise, and to a control process of such a system.

During a journey by a ship comprising a tank of liquid-state gas for consumption and/or delivery to a destination point, said ship should be able to use at least a part of said liquid-state gas to feed at least one of its motors through a gas supply system. This is the case of ships with a ME-GI high-pressure propel engine. To feed such motors, the gas must be compressed to extremely high pressure by special compression devices that are able to compress the gas up to 300 bar absolute, but such compression devices are expensive, generate sizable maintenance costs and induce vibrations in the ship.

An alternative to the installation of such high-pressure compression devices is to boil off liquid-state gas at 300 bar absolute, in particular with a high-pressure pump, before it is sent to the propel engine. Since such a solution cannot remove the vapor-state gas (boil-off gas, BOG) that naturally forms in a tank that at least partially contains the cargo, it is possible to mount a low-pressure compression means to feed an auxiliary motor that is able to consume the gas as a low-pressure vapor. The excess vapor-state gas can also circulate to the tank by recondensation.

The efficiency of such a system is already high, but it remains possible to increase the global performance of this system. One of these improvements is the use of the vapor-state gas to improve the condensation of the excess vapor-state gas that recirculates to the tank.

The present invention aims at implementing such an improvement by proposing a gas supply system of at least one high-pressure gas-consuming device and at least one low-pressure gas-consuming device for a floating structure comprising at least a tank configured to contain the gas at least in liquid state, wherein the gas supply system comprises:
at least a first gas supply circuit for the high-pressure gas-consuming device,
at least a high-pressure evaporator configured to evaporate the gas that flows through the first gas supply circuit,
at least a second gas supply circuit for the low-pressure gas-consuming device comprising at least a compression device configured to compress some gas removed from the tank in vapor state up to a pressure that is compatible with the needs of the low-pressure gas-consuming device,
at least a gas return line connected to the second supply circuit downstream from the compression device and extending to the tank,
at least a first heat exchanger and at least a second heat exchanger, wherein each of them is configured to implement a heat exchange between the vapor-state gas flowing through the gas return line and the liquid-state gas flowing through the first gas supply circuit,
   characterized in that the gas supply system comprises a heat treatment branch of the vapor-state gas that flows through the gas return line, wherein the heat treatment branch is connected to the second gas supply circuit upstream from the compression device, the gas supply system comprising a third heat exchanger configured to implement a heat exchange between the vapor-state gas through the heat treatment branch and the vapor-state gas through the gas return line.

Thus, the gas supply system can use the vapor-state gas from the tank, in particular in the blanket of the tank, to take part in the condensation of the vapor-state gas through the return line. The heat exchange in the third heat exchanger is an additional heat exchange that involves the vapor-state gas that flows through the return line to improve its condensation. The heat exchange in the third heat exchanger is implemented under condition that the vapor-state gas removed from the tank is at a suitable temperature, which means preferably lower than the temperature of the vapor-state gas that flows through the return line at the inlet of the third heat exchanger. If this condition is complied with, then the vapor-state gas flows through the heat treatment branch to flow through the third heat exchanger.

The first gas supply circuit makes it possible to fulfill the fuel requirements of the high-pressure gas-consuming device. It can be, for example, the propulsion means of the floating structure, for example a ME-GI motor. The first supply circuit extends from the tank to the high-pressure gas-consuming device. The liquid-state gas can be removed from the tank thanks to a submerged pump at the bottom of the tank. The submerged pump provides for the pumping of the liquid-state gas, so that it flows through the first gas supply circuit.

Since the gas must be in vapor state to feed the high-pressure gas-consuming device, the high-pressure evaporator provides for the evaporation of the gas before feeding the high-pressure gas-consuming device. The high-pressure evaporator is the location of a heat exchange between the liquid-state gas in the first gas supply circuit and a heat transfer fluid, for example water glycol, sea water or water vapor. This heat transfer fluid, no matter its kind, must have a temperature high enough to generate a phase change of the gas, so that it turns to vapor or supercritical state to feed the high-pressure gas-consuming device.

As a rule, the gas in the tank can turn to vapor in a natural or forced way by the floating structure. The gas in the tank, which turns to vapor, must be released to prevent too much pressure in the tank.

This is provided by the second gas supply circuit of the low-pressure gas-consuming device. Such a second gas supply circuit extends from the tank to the low-pressure gas-consuming device. This can be, for example, an auxiliary motor, such as an internal combustion engine of an electric generator. The function of the compression device on the second gas supply circuit is to suck the gas from the blanket of the tank to feed the low-pressure gas-consuming device and, at the same time, regulate the pressure in the tank.

At the outlet of the compression device, the vapor-state gas can feed the low-pressure gas-consuming device and/or circulate through the return line if the low-pressure gas-consuming device needs no or little fuel supply. Since the return line is connected downstream from the compression device, the vapor-state gas that is sucked by the compression device can circulate through it.

The vapor-state gas in the return line first flows through the second heat exchanger, then through the third heat exchanger, then through the first heat exchanger, before returning to the tank. A heat exchange is implemented in the three heat exchangers above to progressively cool the vapor-state gas that flows through the return line. By flowing through the first heat exchanger and the second heat exchanger, the liquid-state gas that flows through the first gas supply circuit cools the vapor-state gas flowing through the return line. By flowing through the third heat exchanger, the vapor-state gas that flows through the heat treatment branch cools the vapor-state gas flowing through the return line.

Then, the temperature of the vapor-state gas decreases when flowing through the three heat exchangers until said gas condenses and returns to liquid substantially downstream from the first heat exchanger. Then, the condensed gas, in liquid state, flows to the tank.

Since the heat treatment branch is connected to the second gas supply circuit, the gas supply system can be configured so that the vapor-state gas at the outlet of the tank can flow directly through the heat treatment branch and flow through the third heat exchanger before compression by the compression device and keeping on flowing to the low-pressure gas-consuming device or through the return line.

According to a characteristic of the invention, the third heat exchanger comprises a first line on the gas return line between the first heat exchanger and the second heat exchanger, and a second line on the heat treatment branch. In other words, when the vapor-state gas flows through the gas return line, it substantially flows through the first line of the third heat exchanger and through a line of the first heat exchanger and a line of the second heat exchanger.

More specifically, the vapor-state gas is pre-cooled by first flowing through the line of the second heat exchanger. The vapor-state gas is then cooled by flowing through the first line of the third heat exchanger and is eventually condensed by flowing through the line of the first heat exchanger.

It shall be understood that the heat exchanges are implemented in a precise order to optimize the condensation of the vapor-state gas that flows through the return line.

According to a characteristic of the invention, the second supply circuit comprises a divergence zone, where the heat treatment branch and the second supply circuit separate, and a convergence zone, where the heat treatment branch and the second supply circuit join, wherein the heat treatment branch extends between the divergence zone and the convergence zone. The vapor-state gas flows out of the tank until the divergence zone, then either flows to the second gas supply circuit or to the heat treatment branch, before reaching the second gas supply circuit via the convergence zone. This is located at the level of the second gas supply circuit upstream from the compression device, which the vapor-state gas must flow through.

According to a characteristic of the invention, the gas supply system comprises a monitoring unit for the circulation of the gas through the second supply circuit, wherein the heat treatment branch is mounted parallel to the monitoring unit. For example, the monitoring unit can be a valve that can be open or closed, in order, respectively, to allow or prevent the circulation of the vapor-state gas through the second gas supply circuit. When the monitoring unit is closed, the vapor-state gas bypasses the monitoring unit by flowing through the heat treatment branch. For example, the monitoring unit can be an on-off valve.

According to a characteristic of the invention, the heat treatment branch comprises a monitoring device configured to monitor the flow of the vapor-state gas through the heat treatment branch. Just like for the monitoring unit, the monitoring device can be open or closed to allow or prevent the circulation of the vapor-state gas through the heat treatment branch. The monitoring device can also be a valve.

According to a characteristic of the invention, the gas supply system comprises a measurement means for the temperature of the gas removed in vapor state from the tank, and a management device that commands the monitoring unit and the monitoring device.

As mentioned above, the circulation of the vapor-state gas through the heat treatment branch notably depends on the temperature of said gas. So, the temperature of the vapor-state gas in the tank must be measured by the measurement means, which can be, for example, a temperature sensor. According to the temperature of the gas, the management device controls the monitoring unit and the monitoring device to circulate the vapor-state gas in the second gas supply circuit or in the heat treatment branch. The circulation of the vapor-state gas is managed by the management device that closes the monitoring unit and opens the monitoring device or vice versa.

According to a characteristic of the invention, the third heat exchanger is configured to implement a heat exchange between the vapor-state gas through the gas return line, the vapor-state gas through the heat treatment branch and the liquid-state gas through the first gas supply circuit. This is a variant of the structure of the third heat exchanger, which makes it possible to better optimize the cooling of the vapor-state gas that flows through the return line. So, here, the heat exchange in the third heat exchanger is between three lines, where the gas flows in vapor state or in liquid state, wherein the aim is always to cool the vapor-state gas through the return line.

According to a characteristic of the invention, the third heat exchanger comprises a first line on the gas return line between the first heat exchanger and the second heat exchanger, a second line on the heat treatment branch and a third line on the first gas supply circuit between the first heat exchanger and the second heat exchanger. Thus, the heat exchange is between the various lines of the third heat exchanger to cool the vapor-state gas through the first line. The structure of the third heat exchanger can be such that the heat exchanges are between several groups of lines gathered by two or simultaneously between the three lines.

According to a characteristic of the invention, at least the second heat exchanger, the third heat exchanger and the high-pressure evaporator constitute a single heat exchanger module. In other words, two or three units among the second heat exchanger, the third heat exchanger and/or the high-pressure evaporator are gathered in only one heat exchanger. The number of lines through the single heat exchanger module depends on the number of units gathered inside it. Such a configuration can be advantageous, for example to reduce the mechanical size of the gas supply system.

According to a characteristic of the invention, the gas supply system comprises at least a cooling branch for the gas removed in vapor state from the tank connected to the second supply circuit upstream from the compression device, wherein the gas supply system comprises at least one thermal exchanger configured to implement a heat exchange between the vapor-state gas through the cooling branch and the liquid-state gas through the first supply circuit. This is a second embodiment of the gas supply system according to the invention, wherein the gas supply system described above that comprises the heat treatment branch and not the cooling branch is a first embodiment.

The function of the cooling branch is to cool the vapor-state gas intended to circulate through the second gas supply circuit when said gas is at a high temperature. The cooling of the vapor-state gas in the tank is made thanks to the thermal exchanger that implements the heat exchange between said vapor-state gas and the liquid-state gas in the first gas supply circuit.

Thus, the cooling branch has two advantages. On one hand, the vapor-state gas that flows through the thermal exchanger is cooled, which later restricts the energy required for its compression by the compression device in the second gas supply circuit. On the other hand, the liquid-state gas through the first gas supply circuit is warmed up, which later makes its evaporation easier in the high-pressure evaporator by reducing the flowrate of heat transfer fluid required to fully evaporate the liquid-state gas, which also restricts the energy required for the gas supply system to work. It has been estimated that up to 30% of the electrical power consumption of the compression device can be saved when the vapor-state gas flows through the return line for condensation, and up to 45% when the vapor-state gas flows through the second gas supply circuit to be provided to the low-pressure gas-consuming device. Thus, it shall be understood that the gas supply system according to the invention can comprise both the heat treatment branch and the cooling branch at the same time to improve the versatility of said gas supply system.

According to a characteristic of the invention, the cooling branch comprises a monitoring valve configured to monitor the flow of the vapor-state gas through the cooling branch. Just like for the monitoring unit for the second gas supply circuit and the monitoring unit for the heat treatment branch, the monitoring valve can be open or closed to respectively allow or prevent the circulation of the vapor-state gas through the cooling branch.

According to a characteristic of the invention, at least the second heat exchanger, the thermal exchanger and the high-pressure evaporator constitute a single heat exchanger module. Gathering these three exchangers is particularly advantageous, because they are configured to implement a heat exchange under high pressure, hence they are compatible to be gathered.

According to a characteristic of the invention, at least the second heat exchanger, the third heat exchanger and the thermal exchanger and the high-pressure evaporator constitute a single heat exchanger module. As described above, two, three or four units among the second heat exchanger, the third heat exchanger, the thermal exchanger and the high-pressure evaporator can be combined and constitute one single exchanger, for example to restrict the mechanical size and/or the costs of production of said units.

According to a characteristic of the invention, the first gas supply circuit comprises a pump between the first heat exchanger and the second heat exchanger. The pump is located between the first heat exchanger and the second heat exchanger. The pump makes it possible to increase the pressure of the liquid-state gas through the first gas supply circuit, so that its pressure is compatible with the feeding of the high-pressure gas-consuming device. The ideal position is to position the pump between the two heat exchangers. Thus, it is necessary to take care that the gas flowing through the first gas supply circuit and through the first heat exchanger remains liquid at its outlet.

The invention also relates to a control process for a gas supply system as described above, wherein:
at a measurement step, the temperature of the vapor-state gas removed from the tank is measured, then
the vapor-state gas is circulated through the second gas supply circuit if the temperature of the vapor-state gas as measured at the measurement step is higher than a temperature threshold, or
the vapor-state gas is circulated through the heat treatment branch if the temperature of the vapor-state gas as measured at the measurement step is lower than the temperature threshold.

It shall be understood from the various steps of the control process according to the invention that the circulation of vapor-state gas in the tank depends on its temperature. Hence, the following steps of the control process will first depend on the measurement of the temperature of the vapor-state gas. The temperature can be measured with the above-mentioned measurement means.

When the temperature of the vapor-state gas is measured, it is compared with the temperature threshold. The temperature threshold corresponds to a value where the vapor-state gas in the tank can be used or not to take part in the condensation of the vapor-state gas through the return line.

If the temperature of the vapor-state gas is lower than the temperature threshold, it means that the vapor-state gas in the tank has a temperature low enough to cool the vapor-state gas through the return line. The vapor-state gas can then be circulated through the heat treatment branch to flow through the third heat exchanger, then to cool the vapor-state gas through the return line.

If the temperature of the vapor-state gas is higher than the temperature threshold, it means that the vapor-state gas in the tank has a temperature too high to take part in the cooling of the vapor-state gas through the return line.

In this situation, there is no use, and it is possibly counter-productive, to send vapor-state gas into the tank in the heat treatment branch, for the operation of condensation of vapor-state gas flowing through the return line. The vapor-state gas from the tank is then sent to the second gas supply circuit to feed the low-pressure gas-consuming device or for condensation when flowing through the return line.

For example, sending gas from the tank to the second gas supply circuit or to the heat treatment branch is implemented by the management device that opens and/or closes the monitoring unit and/or the monitoring device according to the temperature measured by the measurement means.

According to a characteristic of the process, the temperature threshold is-110° C. Thus, the vapor-state gas is circulated through the heat treatment branch if its temperature is lower than −110° C. or through the second gas supply circuit if its temperature is higher than −110° C.

According to a characteristic of the process:
the vapor-state gas is circulated through the heat treatment branch if the temperature of the vapor-state gas as measured at the measurement step is lower than the temperature threshold, or
the vapor-state gas is circulated through the cooling branch if the temperature of the vapor-state gas as measured at the measurement step is higher than a reference threshold, said reference threshold being higher than the temperature threshold, or
the vapor-state gas is circulated through the second gas supply circuit if the temperature of the vapor-state gas as measured at the measurement step is between the temperature threshold and the reference threshold.

This is the process relative to the second embodiment of the gas supply system according to the invention, which means comprising the heat treatment branch and the cooling branch. As for the first embodiment, the circulation of vapor-state gas in the tank depends on its temperature. The temperature of the vapor-state gas in the tank is measured and compared with the temperature threshold and with the reference threshold, which corresponds to a temperature value higher than the temperature threshold and above where the liquid-state gas in the tank has a temperature high enough to induce a power over-consumption by the compression device when compressing the vapor-state gas from the tank.

If the temperature of the vapor-state gas is lower than the temperature threshold, it means that the vapor-state gas in the tank has a temperature low enough to cool the vapor-state gas through the return line. The vapor-state gas can then be circulated through the heat treatment branch to flow through the third heat exchanger, then to cool the vapor-state gas through the return line.

If the temperature of the vapor-state gas is higher than the reference threshold, it means that the vapor-state gas in the tank has such a temperature that it leads to an over-consumption by the compression device during the compression process.

The vapor-state gas is then circulated through the cooling branch to flow through the thermal exchanger for cooling by the liquid-state gas through the first gas supply circuit, and so to be at a right temperature for compression by the compression device without too much power consumption by it.

If the temperature of the vapor-state gas in the tank is higher than the temperature threshold and lower than the reference threshold, it means that the vapor-state gas in the tank has a temperature too high to take part in the cooling of the vapor-state gas through the return line, but also has a temperature low enough for compression by the compression device without power over-consumption. The vapor-state gas from the tank is then sent to the second gas supply circuit.

As for the first embodiment, the management device manages the circulation of the liquid-state gas in the tank by opening or closing the monitoring unit, the monitoring device and the monitoring valve, as a function of a measured temperature for the vapor-state gas in the tank.

According to a characteristic of the process, the reference threshold is −90° C., wherein the control process comprises a step of condensation of the vapor-state gas through the return line. In other words, the vapor-state gas is circulated through the heat treatment branch if its temperature is lower than −110° C., through the cooling branch if its temperature is higher than −90° C., or through the second gas supply circuit if its temperature is between −90° C. and −110° C. The −90° C. reference threshold is used when the compressed vapor-state gas later flows at least partly through the return line.

When the vapor-state gas is intended to feed the low-pressure gas-consuming device, the reference threshold can be not lower than −150° C.

Other characteristics and advantages of the invention will appear thanks to the following description, on one hand, and thanks to several embodiments produced as a guide and non-limitative with a reference to the appended schematic pictures, on the other hand, where:

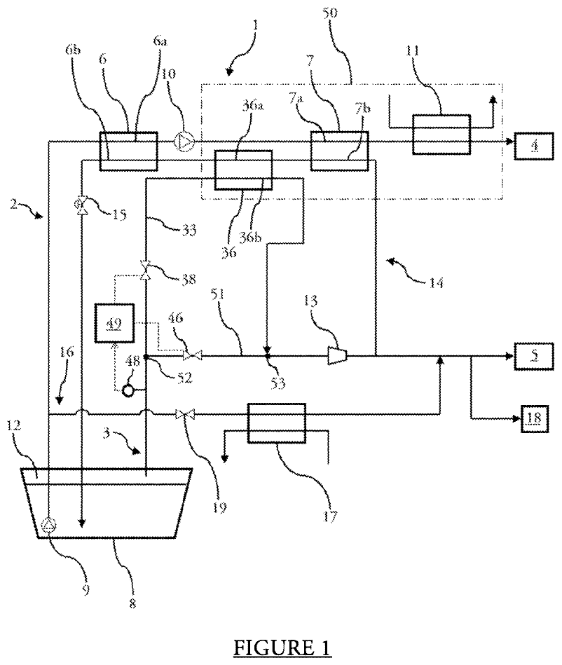

FIG. 1 is a schematic view of a first embodiment of a gas supply system according to the invention,

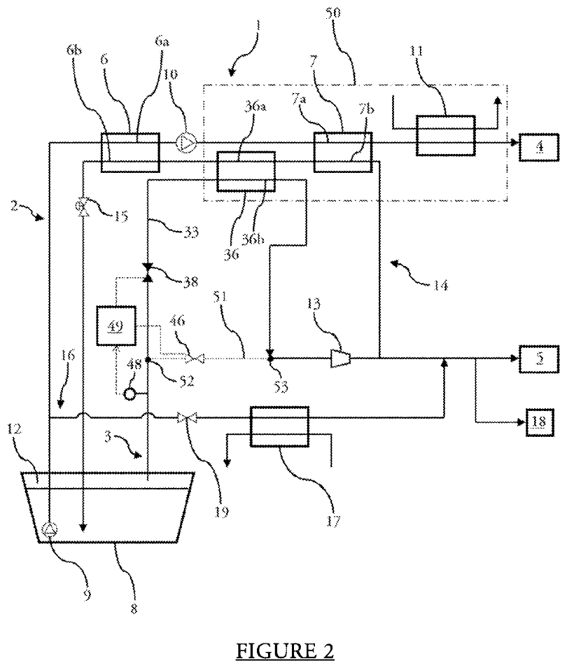

FIG. 2 is a schematic view of a first example of operation of the first embodiment of the gas supply system,

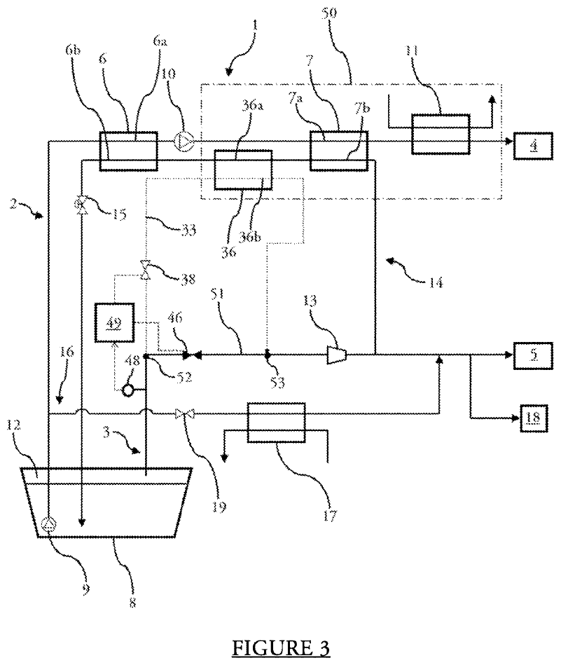

FIG. 3 is a schematic view of a second example of operation of the first embodiment of the gas supply system,

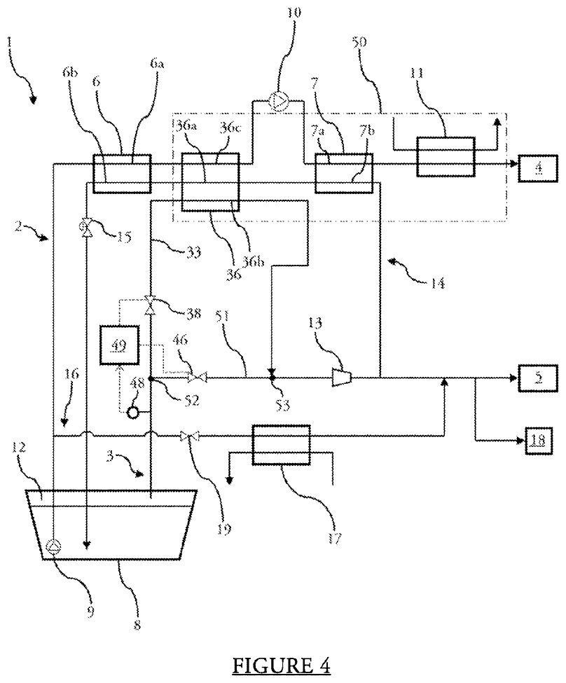

FIG. 4 is a schematic view of a variant of the first embodiment of the gas supply system,

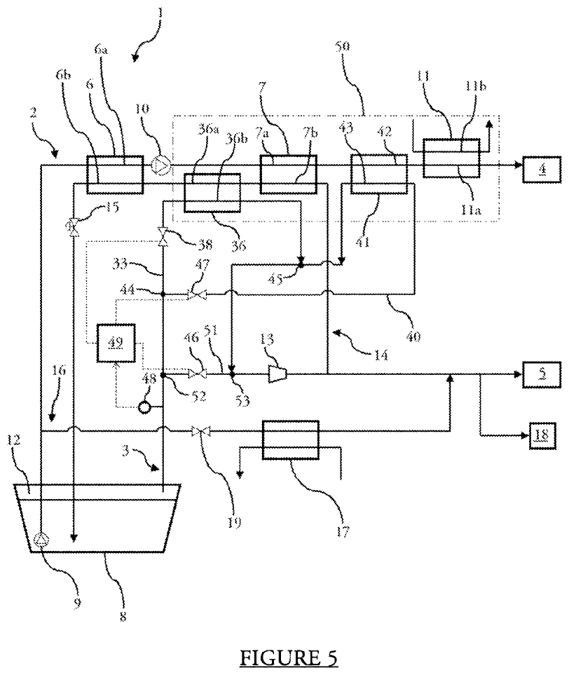

FIG. 5 is a schematic view of a second embodiment of the gas supply system according to the invention,

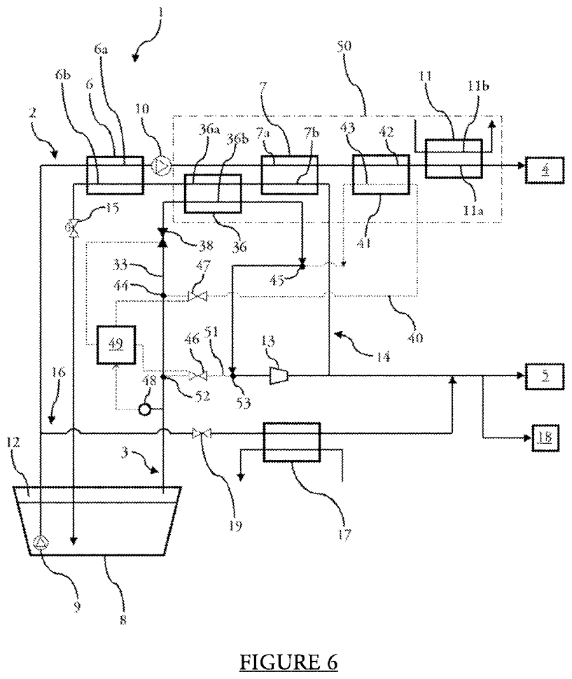

FIG. 6 is a schematic view of a first example of operation of the second embodiment of the gas supply system,

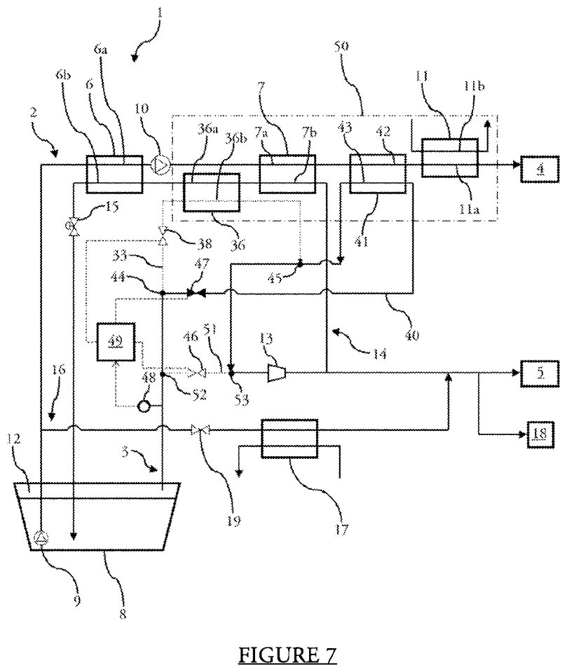

FIG. 7 is a schematic view of a second example of operation of the second embodiment of the gas supply system,

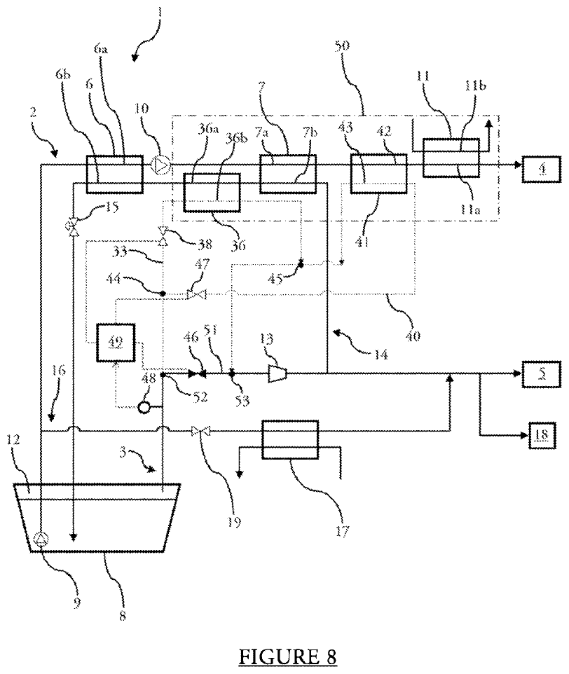

FIG. 8 is a schematic view of a third example of operation of the second embodiment of the gas supply system,

FIG. 1 shows a first embodiment of a gas supply system 1 mounted on a floating structure. The gas supply system 1 makes it possible to circulate gas under liquid state, vapor state, two-phased or under supercritical state from a storing and/or transport tank 8 to a high-pressure gas-consuming device 4 and to a low-pressure gas-consuming device 5 in order to feed them with fuel.

Said floating structure can be, for example, a LNG-carrier-type ship that can store and/or transport liquid-state gas, in particular natural gas. In this case, the gas supply system 1 is able to use the liquid-state gas that the floating structure stores and/or transports to feed the high-pressure gas-consuming device 4, which can be, for example, a propel engine, and the low-pressure gas-consuming device 5, which can be, for example, an electric generator that powers the floating structure.

To guarantee the circulation of the gas from the tank 8 to the high-pressure gas-consuming device 4, the gas supply system 1 comprises a first gas supply circuit 2. The first gas supply circuit 2 comprises a submerged pump 9 located in the tank 8. The submerged pump 9 makes it possible to pump the liquid-state gas and to circulate it, in particular through the first gas supply circuit 2. By sucking the liquid-state gas, the submerged pump 9 increases its pressure up to a value between 6 and 17 bar absolute.

From the tank 8 to the high-pressure gas-consuming device 4, the liquid-state gas flows through a first heat exchanger 6 and is pressurized by a pump 10 that is also called high-pressure pump. Later, the liquid-state gas flows through the second heat exchanger 7, then through a high-pressure evaporator 11, before reaching the high-pressure motor 4. The pump 10 is advantageously located between the first heat exchanger 6 and the second heat exchanger 7.

The high-pressure evaporator 11 makes it possible to change the state of the gas flow through the first gas supply circuit 2 to turn it to vapor or supercritical state. Such a state is compatible with feeding the high-pressure gas-consuming device 4. The evaporation of the liquid-state gas can be made, for example, by heat exchange between the liquid-state gas flowing into the high-pressure evaporator 11 and a heat transfer fluid at a temperature high enough to boil off the liquid-state gas, here water glycol, sea water or water vapor.

The increase of the gas pressure is provided by the pump 10 when it pumps the liquid-state gas. The pump 10 makes it possible to increase the pressure of the liquid-state gas up to a value between 30 and 400 bar absolute, notably for use with ammonia or hydrogen, between 30 and 70 bar absolute for use with liquefied petroleum gas, and preferably between 150 and 400 bar absolute for use with ethane, ethylene, or with a liquefied natural gas predominantly made of methane.

Thanks to the combination of the pump 10 and the high-pressure evaporator 11, the gas is at a pressure and in a state that are compatible with feeding the high-pressure gas-consuming device 4. Such a configuration makes it possible to avoid the installation of high-pressure compression devices on the first gas supply circuit 2, which have cost constraints and generate strong vibrations. In the tank 8, a part of the gas cargo can naturally turn to vapor and spread into the tank blanket 12. To prevent too much pressure in the tank 8, the vapor-state gas in the tank blanket 12 must be bled.

Thus, the gas supply system 1 comprises a second gas supply circuit 3 that uses the vapor-state gas to feed the low-pressure gas-consuming device 5. The second gas supply circuit 3 extends between the tank blanket 12 and the low-pressure gas-consuming device 5. To suck the vapor-state gas contained in the tank blanket 12, the second gas supply circuit 3 comprises a compression device 13, in particular a compressor. In addition to sucking the vapor-state gas, the compression device 13 also makes it possible to compress the vapor-state gas through the second gas supply circuit 3 up to a pressure between 6 and 20 bar absolute so that the vapor-state gas reaches a pressure compatible with feeding the low-pressure gas-consuming device 5. The second gas supply circuit 3 makes it possible to feed the low-pressure gas-consuming device 5 while regulating the pressure in the tank 8 by sucking the vapor-state gas from the tank blanket 12.

The gas supply system 1 further comprises a heat treatment branch 33 that extends between a divergence zone 52 in the second gas supply circuit downstream from the tank 8 and a convergence zone 53 in the second gas supply circuit 3 downstream from the divergence zone 52 and upstream from the compressing device 13. So, the heat treatment branch 33 is mounted parallel to a part 51 of the second gas supply circuit 3, said part 51 extending between the divergence zone 52 and the convergence zone 53. The gas supply system 1 further comprises a third heat exchanger 36 with one of the lines part of the heat treatment branch 33.

Too much vapor-state gas in the tank blanket 12 leads to too much pressure in the tank 8. So, it is necessary to bleed the vapor-state gas to reduce the pressure in the tank 8. Then, for example, the excessive vapor-state gas can be removed by a burner 18, or, in a not pictured way, can be released into the atmosphere. These solutions lead to a loss of cargo. That is why the gas supply system 1 according to the invention comprises a gas return line 14 that extends from the second gas supply circuit 3 to the tank 8.

The gas return line 14 is connected to the second gas supply circuit 3 downstream from the compression device 13 with reference to a direction of flow of the vapor-state gas through the second gas supply circuit 3. The return line 14 first extends through the second heat exchanger 7, then on through the third heat exchanger 36, and eventually through the first heat exchanger 6.

The first heat exchanger 6 comprises a first line 6a that is part of the first gas supply circuit 2. This first heat exchanger 6 comprises a second line 6b that is part of the return line 14. The direction of flow through the first line 6a is opposite to the direction of flow through the second line 6b of the first heat exchanger 6.

The second heat exchanger 7 is located between the first heat exchanger 6 and the high-pressure evaporator 11 on the first gas supply circuit 2.

The second heat exchanger 7 comprises a first line 7a that is part of the first gas supply circuit 2. This second heat exchanger 7 comprises a second line 7b that is part of the return line 14. The direction of flow through the first line 7a is opposite to the direction of flow through the second line 7b of the second heat exchanger 7.

The third heat exchanger 36 is located on the return line 14 between the first heat exchanger 6 and the second heat exchanger 7. This third heat exchanger 36 comprises a first line 36a that is part of the return line 14 and a second line 36b that is part of the heat treatment branch 33. The first line 36a of the third heat exchanger 36 is mounted on the return line 14 between the second line 7b of the second heat exchanger 7 and the second line 6b of the first heat exchanger 6.

Thus, the heat treatment branch 33 is designed to take part in the cooling of the vapor-state gas that flows through the return line 14 to make its condensation easier. In this situation, the heat treatment branch 33 makes it possible to collect the cold from the vapor-state gas removed from the tank 8 and to valorize it by yielding to the return line 14. Such an operation is only suitable if the vapor-state gas in the tank 8 is at a low enough temperature, more generally at a temperature lower than the temperature of the vapor-state gas that flows through the return line 14 at the inlet of the first line 36a of the third heat exchanger 36.

In order to adequately manage the second gas supply circuit 3 and the heat treatment branch 33 according to the temperature of the vapor-state gas in the tank 8, its circulation is designed under the control of a monitoring unit 46. For example, the latter is a valve. The circulation of the vapor-state gas through the heat treatment branch 33 is designed under the control of a monitoring device 38. This monitoring unit 46 and/or this monitoring device 38 is, for example, a valve or an on-off valve.

The heat treatment branch 33 is mounted parallel to the monitoring unit 46. In other words, the divergence zone 52 is located upstream from the monitoring unit 46 of the gas flow through the second gas supply circuit 3, while the convergence zone 53 is located downstream from the same monitoring unit 46.

The gas supply system 1 also comprises a management device 49 and at least one measurement means 48 for the temperature of the vapor-state gas removed from the tank 8. The measurement means 48 of the temperature is, for example, a temperature sensor located on the second gas supply circuit 3 between the tank 8 and the divergence zone 52. Alternatively, the measurement means 48 can be mounted in the tank blanket 12. This measurement means 48 of the temperature is electrically connected to the management device 49, since the data from the measurement means 48 is used in a calculation implemented by the management device 49.

This management device 49 is an electronic control unit that receives the data from the measurement means 48 and that monitors the opening and the closing of the monitoring unit 46 and/or of the monitoring device 38. The management device 49 implements the process and its various steps, except the step of measurement of the temperature of the vapor-state gas removed from the tank 8.

The process of the invention is illustrated by FIG. 2 and FIG. 3, which show two examples of circulation of the vapor-state gas from the tank 8 according to its temperature. In FIGS. 2 and 3, the solid lines show lines through which gas flows, while the dotted lines show lines through which there is no gas flow.

The management device 49 is able to allow the circulation of gas through the heat treatment branch 33, when the temperature of the vapor-state gas removed from the tank 8 and measured by the measurement means 48 is lower than a temperature threshold, wherein such a temperature threshold is, for example, equal to −110° C. To do so, the management device 49 operates the opening of the monitoring device 38, which so allows the vapor-state gas removed from the tank 8 to reach the third heat exchanger 36, in particular its second line 36b. In such a situation, the management device 49 prevents the vapor-state gas from flowing through a part 51 of the second gas supply circuit 3 extending between the divergence zone 52 and the convergence zone 53. To do so, the management device 49 operates a closing of the monitoring unit 46 mounted on the part 51.

As shown in FIG. 3, the management device 49 is also able to prevent the circulation of gas through the heat treatment branch 33, when the temperature as measured by the measurement means 48 is higher than the above-mentioned temperature threshold. In that case, it is counter-productive to make some gas flow at that temperature through the heat treatment branch 33, because this may warm up the vapor-state gas that flows through the return line instead of cooling it. In this configuration, the management device 49 operates the closing of the monitoring device 38 and allows the vapor-state gas to flow through the part 51 of the second gas supply circuit 3 by operating the opening of the monitoring unit 46, hence allowing the vapor-state gas removed from the tank 8 to directly reach the compression device 13.

Of course, the management device 49 can be assigned to other calculation operations required for the function of the gas supply system 1 according to the invention, for example the monitoring of the flowrate regulation unit 15 or the monitoring of the valve 19 that controls the flow of gas through the auxiliary gas supply line 16 or the monitoring of the compression device 13 or the monitoring of the submerged pump 9 or of the pump 10.

Thus, the vapor-state gas flowing through the return line 14 can potentially be cooled by the vapor-state gas contained into the tank if its temperature makes it possible. Then, the liquid-state gas of the first gas supply circuit 2 has its lowest temperature at the inlet of the first line 6a of the first heat exchanger 6. This way, the gas that flows through the return line 14 is condensed after flowing through the first heat exchanger 6. Thus, the fluid in the return line 14 is under vapor state at the inlet of the second line 6b of the first heat exchanger 6 and flows out under liquid state after heat exchange in the first heat exchanger 6.

The return line 14 further comprises a flowrate regulation unit 15 that monitors the flowrate of the fluid through the return line 14. This flowrate regulation unit 15 has a flow area that can be modified. Once the gas is condensed, it flows to the tank 8. Thus, the first heat exchanger 6 is used as a condenser while the flowrate regulation unit 15 monitors the heat exchange in the first heat exchanger 6, in the second heat exchanger 7 and in the high-pressure evaporator 11.

The gas supply system 1 also comprises an auxiliary gas supply line 16 that extends from the first gas supply circuit 2 through a nipple between the submerged pump 9 and the first heat exchanger 6 to the second gas supply circuit 3 with connection to it between the compression device 13 and the low-pressure gas-consuming device 5. The auxiliary gas supply line 16 makes it possible to feed the low-pressure gas-consuming device 5 in case of insufficient vapor-state gas flowrate from the tank blanket 12.

When there is not enough vapor-state gas in the tank blanket 12, the liquid-state gas from the submerged pump 9 can flow through this auxiliary gas supply line 16 to feed the low-pressure gas-consuming device 5. To do so, the auxiliary gas supply line 16 extends through a low-pressure evaporator 17, so that the liquid-state gas that flows through the auxiliary gas supply line 16 turns to vapor. For example, the operation of the low-pressure evaporator 17 can be the same as the high-pressure evaporator 11, which means the gas is boiled off by heat exchange with a heat transfer fluid at a temperature high enough to boil off the liquid-state gas. At the outlet of the low-pressure evaporator 17, the vapor-state gas flows through the auxiliary gas supply line 16, then reaches the second gas supply circuit 3 to feed the low-pressure gas-consuming device 5.

The hereabove implies that the auxiliary gas supply line 16 is used only when there is not enough vapor-state gas in the tank blanket 12.

Thus, the auxiliary gas supply line 16 comprises a valve 19 that monitors the gas flow through the auxiliary gas supply line 16 when its use is not necessary. It shall be noted that each heat exchanger described in this document can be a two-line component. The invention also covers the case of heat exchangers gathered to constitute a single heat exchanger, for example a three- or four-line heat exchanger.

Thus, a combination of two or three of the components among the second heat exchanger 7, the third heat exchanger 36 and the high-pressure evaporator 11 can constitute a single heat exchanger module 50. For example, the gathering into a single heat exchanger module 50 makes it possible to reduce the size resulting from a plurality of independent exchangers.

FIG. 4 shows a variant of the first embodiment of the gas supply system 1 according to the invention. Relatively to what was described about the previous figures, the variant is different by the structure of the third heat exchanger 36. It still comprises the first line 36a that is part of the return line 14 and the second line 36b that is part of the heat treatment branch 33, but it also comprises a third line 36c that is part of the gas supply circuit 2. Thus, it shall be understood that the third heat exchanger 36 according to the variant of FIG. 4 is configured to implement a heat exchange between the vapor-state gas through the return line 14, the vapor-state gas from the tank 8 that flows through the heat treatment branch 33, and the liquid-state gas through the first gas supply circuit 2. Such a variant makes it possible to optimize the cooling of the vapor-state gas through the return line 14 that flows through the first line 36a of the third heat exchanger 36 by using the cold of the liquid-state gas that flows through the first gas supply circuit 2 and through the third line 36c of the third heat exchanger 36. So, this is a three-line heat exchanger that can be combined with the second heat exchanger 7 and/or the high-pressure evaporator 11 to create the single heat exchanger module 50.

Since all these structural and functional elements, except those of the third heat exchanger 36, are identical to what was described above, it shall be referred to the description of the FIG. 1 about the items common to the first embodiment and to its variant.

FIG. 5 shows a second embodiment of the gas supply system 1 according to the invention. This second embodiment corresponds to the first embodiment with additional components added.

Thus, this second embodiment of the gas supply system 1 additionally comprises a cooling branch 40 for the vapor-state gas removed from the tank. Such a line makes it possible to circulate the vapor-state gas removed from the tank 8 to cool it.

The cooling branch 40 is connected to the second gas supply circuit 3 upstream from the compressing device 13 via a divergence point 44 and a convergence point 45 specifics to the cooling branch 40. Alternatively, the cooling branch 40 and the heat treatment branch 33 can both be connected to the divergence zone 52 and to the convergence zone 53. Whatever the connection mode, the heat treatment branch 33 and the cooling branch 40 are mounted parallel to each other and to the part 51 of the second gas supply circuit 3.

The gas supply system 1 pictured in FIG. 5 also comprises a thermal exchanger 41 intended to cool the vapor-state gas removed from the tank by heat exchange with the liquid-state gas that flows through the first supply circuit 2.

This thermal exchanger 41 comprises a first line 42 that exchanges calories with a second line 43 part of this thermal exchanger 41. The first line 42 of the thermal exchanger 41 is part of the first gas supply circuit 2 with the liquid-state gas flowing through it, while the second line 43 of the thermal exchanger 41 is part of the cooling branch 40 with the vapor-state gas from the tank 8 flowing through it.

Ingeniously, the first line 42 of the thermal exchanger 41 is fluidically located between the first line 7a of the second heat exchanger 7 and the first line 11a of the high-pressure evaporator 11.

Such a location makes it possible to cool the vapor-state gas that flows through the cooling branch 40 by heat exchange with the liquid-state gas that flows through the first gas supply circuit 2, which eventually makes it possible to reduce the flow volume at the inlet of the compressing device 13, hence to reduce its consumption, in particular its power consumption.

This location also makes it possible to reduce the flowrate of heat transfer fluid through a second line 11b of the high-pressure evaporator 11 to boil off the liquid-state gas from the tank 8. Since it is a hot source, the invention makes it possible to reduce the amount of calories that the heat transfer fluid provides, since a part of the calories is provided by the vapor-state gas that flows through the cooling branch 40.

The cooling branch 40 further comprises a monitoring valve 47 configured to monitor the flow of the vapor-state gas through the cooling branch 40. This monitoring valve 47 is designed under the control of the management device 49 and is in open position when the temperature of the vapor-state gas removed from the tank 8, as measured by the measurement means 48, is higher than a reference threshold, for example equal to −90° C., when the vapor-state gas mostly or exclusively flows through the return line 14. In this configuration, the reference threshold is higher than the temperature threshold.

Alternatively, the reference threshold is not lower than −150° C. when the vapor-state gas is mostly or exclusively sent to the low-pressure gas-consuming device 5 via the second gas supply circuit 3. In such a case, the flowrate regulation unit 15 reduces the gas flowrate through the return line 14 or possibly stops it completely.

When the temperature of the vapor-state gas as measured by the measurement means 48 is lower than a reference threshold, the management device 49 operates the closing of the monitoring valve 47.

In the case of the second embodiment, the above-mentioned single heat exchanger module 50 can be complemented with the thermal exchanger 41. Such a single heat exchanger module 50 can then comprise at least five lines that are fluidically separated from each other. Advantageously, the single heat exchanger module 50 can gather the second heat exchanger 7, the thermal exchanger 41 and the high-pressure evaporator 11, these three exchangers being high-pressure exchangers.

FIGS. 6 to 8 show examples of circulation of the vapor-state gas from the tank 8 through the second gas supply circuit 3, the heat treatment branch 33 or the cooling branch 40 according to the measured temperature of the vapor-state gas in the tank 8. The circulation of the vapor-state gas from the tank 8 is managed by the management device 49 that opens or closes the monitoring unit 46, the monitoring device 38 or the monitoring valve 47 according to the temperature for the vapor-state gas in the tank 8 as measured by the measurement means 48 for the temperature and according to the comparison of this temperature with the above-mentioned temperature threshold and reference threshold. As for FIGS. 2 and 3, the solid lines show lines through which gas flows, while the dotted lines show lines through which there is no gas flow.

Thus, FIG. 6 corresponds to the circulation of the vapor-state gas from the tank 8 when the measured temperature of the vapor-state gas from the tank 8 is lower than the temperature threshold, which means that the vapor-state gas from the tank 8 has a temperature low enough to take part in the cooling of the vapor-state gas through the return line 14.

In response to this measured temperature by the measurement means 48, the management device 49 closes the monitoring unit 46 and the monitoring valve 47 and opens the monitoring device 38, so that the vapor-state gas from the tank 8 flows through the heat treatment branch 33 and through the second line 36b of the third heat exchanger 36 to cool the vapor-state gas that flows through the return line 14 and the first line 36a of the third heat exchanger 36.

FIG. 7 corresponds to the circulation of the vapor-state gas from the tank 8 when the measured temperature of the vapor-state gas from the tank 8 is higher than the reference threshold, which means that the vapor-state gas from the tank 8 has a temperature too high for the compression device 13 to compress it without over-consuming energy. To prevent said overconsumption of energy, the vapor-state gas from the tank 8 must be cooled before compression. To do so, the management device 49 closes the monitoring unit 46 and the monitoring device 38 and opens the monitoring valve 47, so that the vapor-state gas from the tank 8 flows through the cooling branch 40 and through the second line 43 of the thermal exchanger 41 to be cooled by the liquid-state gas that flows through the second gas supply circuit 2 and through the first line 42 of the thermal exchanger 41. The cooled vapor-state gas in the thermal exchanger 41 can then flow to the compression device 13 and be compressed without energy over-consumption.

FIG. 8 corresponds to the circulation of the vapor-state gas from the tank 8 when the measured temperature of the vapor-state gas from the tank 8 is between the temperature threshold and the reference threshold, which means higher than the temperature threshold and lower than the reference threshold.

Thus, in this configuration, the temperature of the vapor-state gas in the tank 8 is low enough for compression by the compression device 13 without energy over-consumption, but too high to take part in the cooling of the vapor-state gas in the return line 14 anyway. It can be counter-productive to make the vapor-state gas flow in the tank 8 through the heat treatment branch 33.

In this configuration, the management device 49 closes the monitoring device 38 and the monitoring valve 47 and opens the monitoring unit 46, so that the vapor-state gas from the tank 8 directly flows through the second gas supply circuit 3 via the part 51 for direct compression by the compression device 13 for later consumption by the low-pressure gas-consuming device 5 or recondensation in the return line 14.

Of course, the invention is not restricted to the examples above, and many refinements may be added to these examples in the framework of the invention.

The invention, as described above, reaches the goal it was assigned and suggests a gas supply system that takes advantage of the cold of the vapor-state gas in a tank to implement a condensation of said vapor-state gas. Variants that are not described here could be implemented in the frame of the invention as soon as, according to the invention, they comprise a gas supply system according to the invention.

1. A gas supply system of at least one high-pressure gas-consuming device and at least one low-pressure gas-consuming device for a floating structure comprising at least a tank configured to contain the gas at least in liquid state, wherein the gas supply system comprises:
at least a first gas supply circuit for the high-pressure gas-consuming device,
at least a high-pressure evaporator configured to evaporate the gas that flows through the first gas supply circuit,
at least a second gas supply circuit for the low-pressure gas-consuming device comprising at least a compressor configured to compress some gas removed from the tank in vapor state up to a pressure that is compatible with the needs of the low-pressure gas-consuming device,
at least a gas return line connected to the second supply circuit downstream from the compressor and extending to the tank,
at least a first heat exchanger and at least a second heat exchanger, wherein each of them is configured to implement a heat exchange between the vapor-state gas flowing through the gas return line and the liquid-state gas flowing through the first gas supply circuit,
wherein the gas supply system comprises a heat treatment branch of the vapor-state gas through the gas return line, wherein the heat treatment branch is connected to the second supply circuit upstream from the compressor, the gas supply system comprising a third heat exchanger configured to implement a heat exchange between the vapor-state gas through the heat treatment branch and the vapor-state gas through the gas return line.

2. A gas supply system according to claim 1, wherein the third heat exchanger comprises a first line on the gas return line between the first heat exchanger and the second heat exchanger, and a second line on the heat treatment branch.

3. A gas supply system according to claim 1, wherein the second supply circuit comprises a divergence zone where the heat treatment branch and the second supply circuit separate, and a convergence zone where the heat treatment branch and the second supply circuit join, wherein the heat treatment branch extends between the divergence zone and the convergence zone.

4. A gas supply system according to claim 1, comprising a monitoring unit for the circulation of the gas through the second supply circuit, wherein the heat treatment branch is mounted parallel to the monitoring unit.

5. A gas supply system according to claim 4, wherein the heat treatment branch comprises a monitoring device configured to monitor the flow of the vapor-state gas through the heat treatment branch.

6. A gas supply system according to claim 5, comprising a measurement means for the temperature of the gas removed in vapor state from the tank, and a management device that commands the monitoring unit and the monitoring device.

7. A gas supply system according to claim 1, wherein the third heat exchanger is configured to implement a heat exchange between the vapor-state gas through the gas return line, the vapor-state gas through the heat treatment branch and the liquid-state gas through the first gas supply circuit.

8. A gas supply system according to claim 7, wherein the third heat exchanger comprises a first line on the gas return line between the first heat exchanger and the second heat exchanger, a second line on the heat treatment branch and a third line on the first gas supply circuit between the first heat exchanger and the second heat exchanger.

9. A gas supply system according to claim 1, wherein at least the second heat exchanger, the third heat exchanger and the high-pressure evaporator constitute a single heat exchanger module.

10. A gas supply system according to claim 1, comprising at least a cooling branch for the gas removed in vapor state from the tank connected to the second supply circuit upstream from the compressor, wherein the gas supply system comprises at least one heat exchanger configured to implement a heat exchange between the vapor-state gas through the cooling branch and the liquid-state gas through the first supply circuit.

11. A gas supply system according to claim 10, wherein the cooling branch comprises a monitoring valve configured to monitor the flow of the vapor-state gas through the cooling branch.

12. A gas supply system according to claim 10, wherein at least the second heat exchanger, the heat exchanger and the high-pressure evaporator constitute a single heat exchanger module.

13. A gas supply system according to claim 12, wherein at least the second heat exchanger, the third heat exchanger, the heat exchanger and the high-pressure evaporator constitute a single heat exchanger module.

14. A gas supply system according to claim 1, wherein the first gas supply circuit comprises a pump between the first heat exchanger and the second heat exchanger.

15. A control process for a gas supply system according to claim 1, wherein:
at a measurement step, the temperature of the vapor-state gas removed from the tank is measured, then
the vapor-state gas is circulated through the second gas supply circuit if the temperature of the vapor-state gas as measured at the measurement step is higher than a temperature threshold, or
the vapor-state gas is circulated through the heat treatment branch if the temperature of the vapor-state gas as measured at the measurement step is lower than the temperature threshold.

16. A control process according to claim 15, where the temperature threshold is −110° C.

17. A control process according to claim 15, wherein:
the gas supply system comprises at least a cooling branch for the gas removed in vapor state from the tank connected to the second supply circuit upstream from the compressor, wherein the gas supply system comprises at least one heat exchanger configured to implement a heat exchange between the vapor-state gas through the cooling branch and the liquid-state gas through the first supply circuit,
the vapor-state gas is circulated through the heat treatment branch if the temperature of the vapor-state gas as measured at the measurement step is lower than the temperature threshold, or
the vapor-state gas is circulated through the cooling branch if the temperature of the vapor-state gas as measured at the measurement step is higher than a reference threshold, said reference threshold being higher than the temperature threshold, or
the vapor-state gas is circulated through the second gas supply circuit if the temperature of the vapor-state gas as measured at the measurement step is between the temperature threshold and the reference threshold.

18. A control process according to claim 17, where the reference threshold is −90° C., wherein the control process comprises a step of condensation of the vapor-state gas through the gas return line.
